(19) United States
(12) Patent Application Publication
(10) Pub. No.: US 2015/0099477 A1
(43) Pub. Date: Apr. 9, 2015

(54) PORTABLE APPARATUS AND CUMULATIVE TIME DISPLAY CONTROL METHOD

(71) Applicant: Seiko Epson Corporation, Shinjuku-ku (JP)

(72) Inventor: Reiko SATO, Azumino-shi (JP)

(21) Appl. No.: 14/506,521

(22) Filed: Oct. 3, 2014

(30) Foreign Application Priority Data
Oct. 7, 2013 (JP) 2013-209933

(51) Int. Cl. H04B 1/38; H04W 64/00; H04W 4/02

(52) U.S. Cl. CPC H04B 1/385; H04W 4/02; H04W 64/006
USPC 455/90.1

(57) ABSTRACT

A portable apparatus can receive a GPS signal from a GPS satellite and obtain positioning information. The portable apparatus can thus present a distance traveled. The portable apparatus can clock gross time from competition start specified time or in response to clocking initiation operation each of which serves as clocking initiation timing. The portable apparatus can further initiate clocking concurrently with or after the gross time clocking initiation and clock net time the clocking of which can be temporarily discontinued and resumed. The gross time and the net time can be displayed on a touch panel.

### BACKGROUND

1. Technical Field

The present invention relates, for example, to a mobile apparatus capable of clocking and displaying cumulative time.

2. Related Art

There is a known apparatus that measures a cumulative travel distance by using the GPS (global positioning system) (see JP-A-2003-322545, for example). An apparatus of this type is used in the form of a wristwatch-shaped, wearable, portable electronic apparatus (hereinafter referred to as “portable apparatus”) having a positioning function of determining the current position on the earth and called, for example, a “running watch,” a “training watch,” and a “runner's watch.” A portable apparatus of this type includes, for example, a timepiece, a GPS receiver, a computation device, and a storage medium. When a user who is doing running exercise operates the portable apparatus to start positioning, the portable apparatus automatically and continuously stores positioning information containing periodically measured latitude, longitude, and other parameters. The positional information and other information stored in the portable apparatus during the running exercise is analyzed by an external apparatus, such as a personal computer, and the analysis result is used to display the path along which the user has run on a map (mapping) and compute the pace, pitch, and other parameters associated with the running exercise and display changes in them over the period from the start of the running exercise to the end thereof in the form of graphs. The user can use the displayed map and graphs to achieve efficient training.

In recent years, an increasing number of users use portable apparatus of the type described above in a competition. Portable apparatuses of related art are, however, not capable enough to user's satisfaction to display useful information that allows the user to achieve a good result in a competition. For example, several thousands to several tens of thousands runners participate a marathon event in some cases, and most of the runners are far away from the start point when they hear the start signal gun. That is, an event official record clocked from the start signal gun and a running period for which a runner has run and which is clocked from a point of time when the runner actually passes the start point differ from each other. It can be said that the clocked timed that is the event official record and called gross time, the clocked time measured from the point of time when an individual runner passes the start point and called net time, and other parameters form the useful information (hereinafter referred to as “competition-related information”).

### SUMMARY

An advantage of some aspects of the invention is to provide a portable apparatus capable of presenting a user with competition-related information.

A first aspect of the invention relates to a portable apparatus including a first clocking section that initiates clocking from given clocking initiation timing and clocks a first cumulative time, a second clocking section that initiates clocking concurrently with or after the clocking initiation timing and clocks a second cumulative time, and a cumulative time display control section that controls display of the first cumulative time and the second cumulative time.

As another aspect, the first aspect of the invention may be configured as a cumulative time display control method including initiating clocking from given clocking initiation timing and clocking a first cumulative time, initiating clocking concurrently with or after the clocking initiation timing and clocking a second cumulative time, and displaying the first cumulative time and the second cumulative time.

According to the first aspect of the invention and the another aspect thereof, the first cumulative time clocked from the predetermined clocking initiation timing and the second cumulative time the clocking of which is initiated concurrently with or after the clocking of the first cumulative time can be displayed. In a marathon event, for example, the first cumulative time can be displayed as gross time, and the second cumulative time can be displayed as net time, whereby competition-related useful information can be presented to a user.

A second aspect of the invention relates to the portable apparatus according to the first aspect of the invention, in which the first clocking section initiates the clocking of the first cumulative time at given specified time as the clocking initiation timing.

For example, in a large-scale competition in which several thousands to several tens of thousands participants are involved, depending on the environment in which a user waits for a start signal, the user cannot hear the start signal gun, and the user himself/herself is possibly unable to initiate the clocking of the first cumulative time. The second aspect of the invention, however, allows automatic initiation of the clocking of the first cumulative time at the specified time, whereby the first cumulative time can be accurately clocked with respect, for example, to clocking initiation official specified time.

A third aspect of the invention relates to the portable apparatus according to the first or second aspect of the invention, in which the portable apparatus further includes a positioning section, 1) a travel distance calculation section that calculates a travel distance from a given start point by using a positioning result from the positioning section, 2) a passage limit information setting section that sets, in accordance with an operation input from a user and by using a positioning result from the positioning section, limit time expressed in the form of a period having elapsed from the clocking initiation timing or in the form of clock time and a limit point that is a point expressed in distance where the user unable to pass the point in the limit time is rejected, 3) a remainder information display control section that controls display of a remaining period before the limit time and a remaining distance to the limit point by using a positioning result from the positioning section.

A fourth aspect of the invention relates to the portable apparatus according to the third aspect of the invention, which further includes a traveling pace calculation section that calculates a traveling pace by using a positioning result from the positioning section, an expected arrival time calculation section that calculates expected arrival time at which the user arrives at the limit point by using the traveling pace, and an expected arrival time display control section that controls display of the limit time and the expected arrival time.

A fifth aspect of the invention relates to the portable apparatus according to the fourth aspect of the invention, which further includes a pace display control section that controls display of a given target pace and the traveling pace.

According to the third to fifth aspects of the invention, for example, in a competition in which a participant who cannot pass the limit point in predetermined period clocked from the initiation of clocking of the first cumulative time, that is, in the limit time is not allowed to continue the competition, information that allows the user to determine whether or not the pace should be so increased that the user can continue the competition can be displayed.

The fourth aspect of the invention is more effective because not only expected arrival time at which the user is expected to arrive at the limit point when the current traveling pace is maintained but also the limit time can be displayed. In the fifth aspect of the invention, a target pace can further be displayed, whereby the user readily determines whether the pace should be further increased.

A sixth aspect of the invention relates to the portable apparatus according to any of the third to fifth aspects of the invention, in which the limit time is expressed in a period having elapsed from the clocking initiation timing and the portable apparatus further includes a limit time comparison display control section that controls display of the limit time and the first cumulative time.

According to the sixth aspect of the invention, the limit time and the first cumulative time compared with each other can further be displayed.

A seventh aspect of the invention relates to the portable apparatus according to any of the third to sixth aspects of the invention, which further includes a passage target time setting section that sets, in accordance with an operation input from the user, passage target time at which the user passes a given passage point expressed in distance and a target reference remainder information display control section that controls display of a remaining period from the second cumulative time to the passage target time and a remaining distance to the passage point.

According to the seventh aspect of the invention, the user can arbitrarily set a passage point, and the remaining period before the passage target time at which the user aims to pass the passage point and the remaining distance to the passage point can be displayed.

### BRIEF DESCRIPTION OF THE DRAWINGS

The invention will be described with reference to the accompanying drawings, wherein like numbers reference like elements.

FIG. 1 shows an example of the configuration of a portable apparatus.

FIG. 2 describes information on a competition supported by the portable apparatus.

FIG. 3 shows an example of an input screen to which competition specification values are inputted.

FIGS. 4A to 4C describe gross time (first cumulative time) clocking.

FIGS. 5A to 5D describe net time (second cumulative time) clocking.

FIG. 6 shows an exemplary display screen showing an example of competition-related information display and specifically shows an example of a first display format.

FIG. 7 shows an exemplary display screen showing an example of the competition-related information display and specifically shows an example of a second display format.

FIG. 8 shows an exemplary display screen showing an example of the competition-related information display and specifically shows an example of a third display format.

FIG. 9 shows an exemplary display screen showing an example of the competition-related information display and specifically shows an example of a fourth display format.

FIG. 10 shows an exemplary display screen showing an example of the competition-related information display and specifically shows an example of a fifth display format.

FIG. 11 is a functional block diagram showing an example of the functional configuration of the portable apparatus.

FIG. 12 shows an example of the data configuration of competition specification value data.

FIG. 13 shows an example of the data configuration of competition data.

FIG. 14 is a flowchart for describing the procedure of processes associated with competition assistance in the portable apparatus.

FIG. 15 is a flowchart as a continuation of the flowchart in FIG. 14.

FIG. 16 shows a variation of the portable apparatus.

### DESCRIPTION OF EXEMPLARY EMBODIMENTS

### First Embodiment

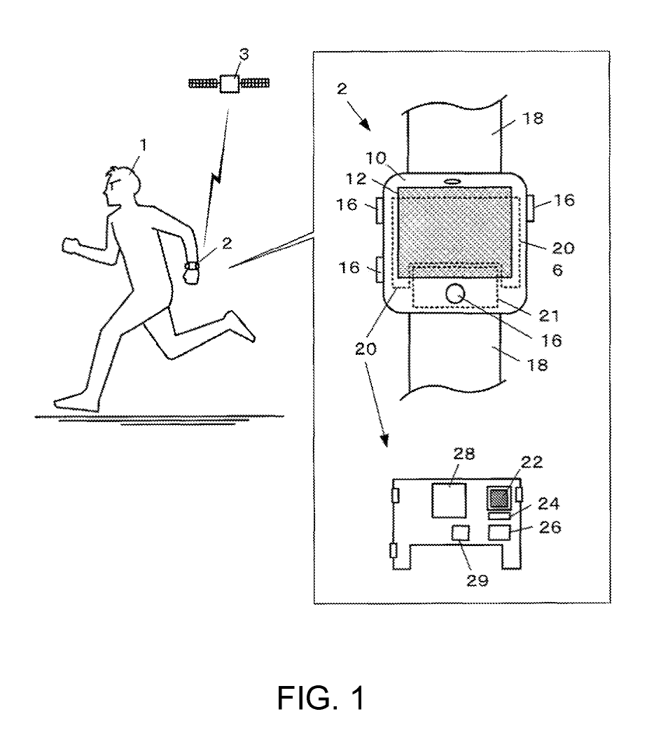

FIG. 1 shows an example of the configuration of a portable apparatus in an embodiment of the invention.

A portable apparatus 2 according to the present embodiment is a portable electronic apparatus that can be worn around a wrist or an arm of a user 1 as a wristwatch can. The portable apparatus 2 is a wearable computer classified into a wristwatch or a running watch in terms of external appearance.

A touch panel 12 is provided on the upper surface of a main frame 10 of the portable apparatus 2. Further, a single or multiple operation switches 16 for a variety of operation inputs and a band 18 are provided on the side surface of the main frame 10. The band 18 is an attachment support portion. The portable apparatus 2 can be fixed to a wrist, an arm, or an ankle when the band 18 is wound therearound, as a wristwatch can.

The main frame 10 forms an airtight compartment and accommodates a substrate 20, which is electrically connected to the touch panel 12, the operation switches 16, and other components, and a rechargeable battery 21, which supplies the substrate 20 and other components with electric power. The rechargeable battery 21 can be charged in an appropriate manner. For example, the portable apparatus 2 may be placed in a cradle connected to a household wall socket to allow the portable apparatus 2 to be energized or charged via the cradle through electric contacts provided on the rear surface of the main frame 10 or may be wirelessly charged.

The substrate 20 oversees and controls the portable apparatus 2. Specifically, a CPU (central processing unit) 22, a main memory 24, a measured data memory 26, a positioning module 28, and a short-range wireless module 29 are mounted on the substrate 20. Further, a power supply management IC, a driver IC that drives the touch panel 12, and other ICs and electronic parts can be mounted on the substrate 20 as appropriate.

The main memory 24 is a storage medium capable of storing not only programs and initial setting data but also computed values from the CPU 22. The main memory 24 is achieved, for example, by using a RAM (random access memory), a ROM (read only memory), or a flash memory as appropriate.

The measured data memory 26, which is a data rewritable, nonvolatile memory, is a storage medium for storing measured data including positioning information. In the present embodiment, the measured data memory 26 is a flash memory but may instead be a ferroelectric memory, a magneto-resistive memory, or any other rewritable nonvolatile memory.

The positioning module 28 can receive a signal provided from a positioning system and output positioning information to the CPU 22 at a predetermined cycle (every second). In the present embodiment, the GPS is used as the positioning system. The positioning module 28 can therefore, for example, be a known “GPS module” or “GPS receiver.” The “positioning information” contains coordinated universal time (UTC), position coordinates (latitude and longitude), ground speed (scalar quantity), and velocity azimuth (traveling direction with respect to true north of 0°, for example). The ground speed and the velocity azimuth may collectively be calculated in the form of velocity. Further, the ground speed and the velocity azimuth are calculated based on a Doppler shift (also called Doppler) produced in a signal issued from a GPS satellite. The positioning information may contain other types of information as appropriate.

The system used in the positioning is not limited to the GPS and may be Galileo or any other satellite navigation system. An electric wave from a base station the ground position of which is known may be additionally used. The position may instead be determined based on an inertial navigation method by using a velocity sensor, an acceleration sensor, or any other sensor.

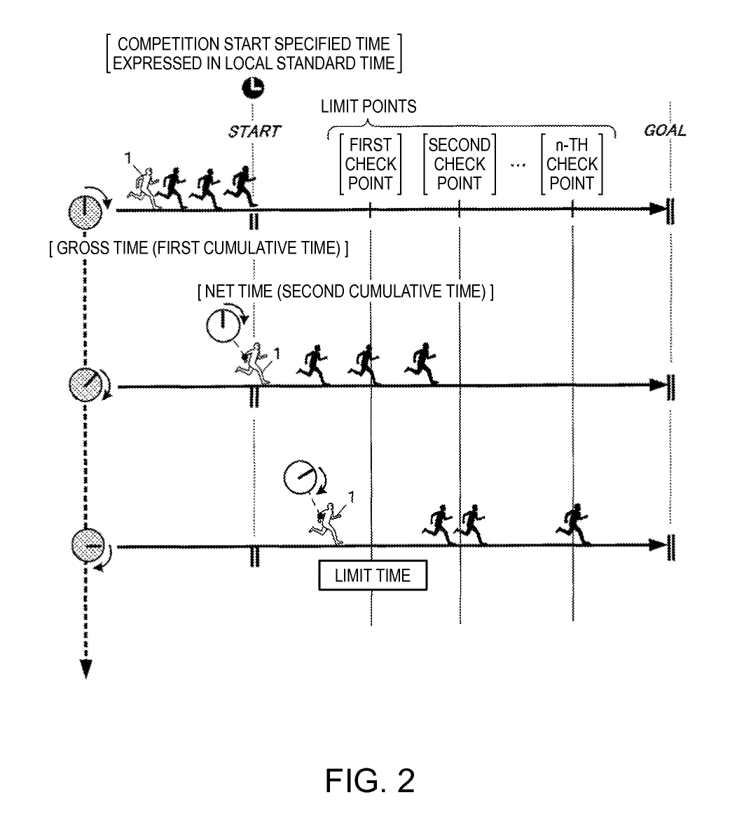

FIG. 2 describes information on a competition supported by the portable apparatus 2 according to the present embodiment.

A conceivable competition supported by the portable apparatus 2 is a large-scale competition in which a large number of participants are involved, for example, TOKYO MARATHON and other similar marathon events. It is assumed in the present embodiment that the user 1 who uses the portable apparatus 2 is not an invited participant who can occupy a position close to the start point at the time of start but is a general runner who occupies a position apart back from the start point, can move only after a runner in front of him/her starts moving, and starts the marathon competition when he/she passes the start point in order. The left white character in FIG. 2 represents such a general runner.

As a known rule, a marathon event starts when the local standard time reaches specified time (competition start specified time), and official time is clocked based on the specified time as clocking initiation timing. The thus clocked time is called “gross time (first cumulative time).” In the case of an invited participant, who starts running from a position close to the start point, the gross time recorded when he/she passes the finish point is immediately a period required for the runner to run through the marathon course.

On the other hand, the user 1, who is a general runner, is still in a position apart back from the start point when the competition start specified time is reached. At the competition start time, the user 1 is not on the start point. Further, the user 1 can start running only after runners in front of the user 1 start running and a space is created in front of the user 1. As a result, the user 1 actually reaches the start point after a certain amount of time has elapsed from the competition start specified time described above.

That is, the official time or, the gross time cannot accurately represent a period substantially required for the user 1 to run through the competition course. The correct time is second cumulative time that starts being clocked when the user 1 actually passes the start point and is accumulated until the user passes the finish point. The correct time is called “net time (second cumulative time).” On the other hand, the user 1 may be an invited participant or can start the competition in a position close to the start point in some cases. Including these cases, the portable apparatus 2 according to the present embodiment can initiate clocking of the net time concurrently with or after the gross time clocking initiation timing.

Further, the net time is not all the user 1 needs to know in a competition. In a marathon event, “limit points” called check points (first check point, second check point, . . . , n-th check point in FIG. 2) are set in some cases, and a runner who cannot pass each check point in “limit time” expressed by the time having elapsed from the gross time clocking initiation timing is not allowed to continue the competition afterward. The user 1, who is a general runner, therefore needs not only to know the net time (second cumulative time) but also, more importantly, to always know the gross time (first cumulative time) to control the pace in such a way that the user 1 can pass a next check point in limit time.

The portable apparatus 2 according to the present embodiment exactly satisfies the requirements, that is, has a function of clocking the gross time and the net time and presenting the user with a variety of types of necessary competition-related information based on the clocked gross time and net time.

### Description of Specification Value Input

As basic data used to present the user with competition-related information, competition specification values first need to be inputted to the portable apparatus 2 according to the present embodiment.

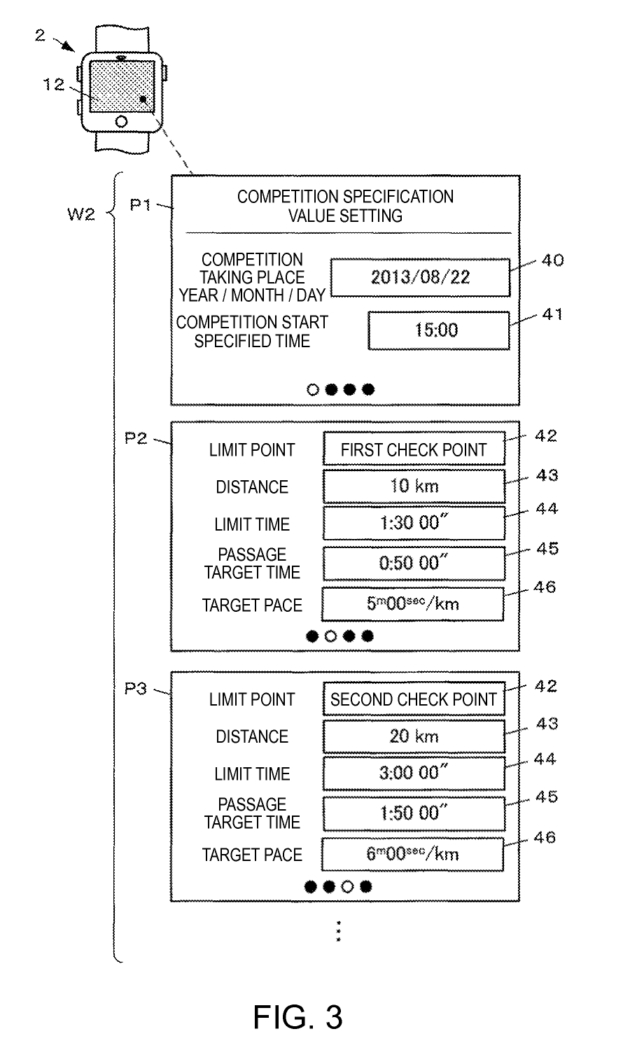

FIG. 3 shows an example of an input screen to which competition specification values are inputted.

A competition specification value input screen W2 in the present embodiment is formed of a main page P1 and a plurality of sub-pages P2, P3, . . . added automatically (or in response to predetermined page addition operation) one by one.

The main page P1 has input fields to which specification values associated with an overall competition are inputted. In the present embodiment, the main page P1 has an input field 40, to which competition taking place year/month/day expressed in local standard time is inputted, and an input field 41, to which competition start specified time expressed in local standard time is inputted. In addition to the input fields described above, a field to which a competition distance is inputted and other fields can be added as appropriate.

The sub-pages P2, P3, . . . are pages to which specification values on a limit point basis are inputted. In the present embodiment, each of the sub-pages has an input field 42, to which information that allows identification of a limit point is inputted, an input field 43, to which the distance from the start point to the limit point in question is inputted, an input field 44, to which limit time at the limit point in question is inputted, an input field 45, to which passage target time arbitrarily set by the user 1 is inputted, and an input field 46, to which a target pace at which the user 1 aims in the run to the limit point is inputted. Depending on an intended competition, input fields other than those described above can, of course, be set as appropriate.

The limit time is expressed in the form of the time having elapsed from the gross time (first cumulative time) clocking initiation timing or the local standard time (clock time). The passage target time is expressed in the form of the time having elapsed from the net time (second cumulative time) clocking initiation.

The specification values associated with the limit point in each of the sub-pages are not necessarily set for a limit point officially set in a competition or what is called a “check point” but can be set by the user 1 in association with an arbitrary passage point other than the check points. For example, the limit point identification information associated, for example, with “user's own target passage point” may include the distance to the passage point, limit time as target time at the passage point with respect to the gross time, and passage target time as target time with respect to the net time.

The touch panel 12 cannot display all the pages together in a single screen, but predetermined display operation (flick operation, for example) allows page turning for display of information on a desired page. Any known technology is applicable to an input field fill-in method as appropriate. For example, when the user touches an input field that the user desires to fill in, the input field may be activated and software ten keys may be displayed on the screen. The user may then touch the ten keys to input values and characters. Instead, input operation may be performed by operation of any of the operation switches 16.

### Description of Clocking

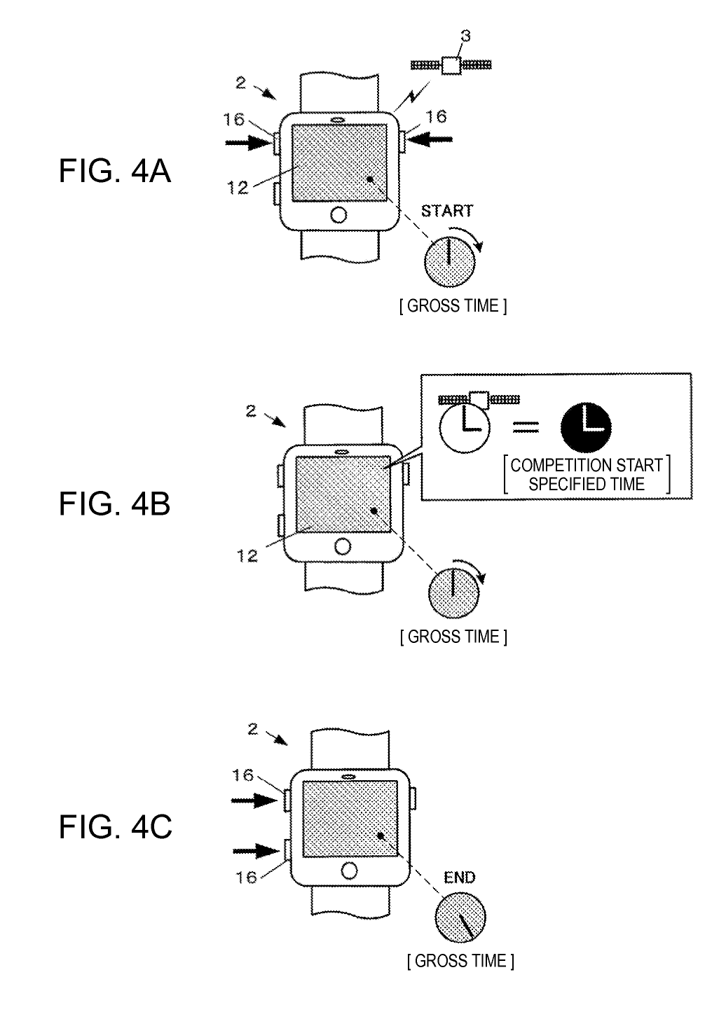

FIGS. 4A to 4C describe clocking of the gross time (first cumulative time).

When an input of predetermined gross time (first cumulative time) clocking initiation operation (two filled arrows in FIG. 4A) is detected, gross time clocking can be initiated, as shown in FIG. 4A.

Even when the gross time (first cumulative time) clocking initiation operation is not performed, but when the competition start specified time inputted and set in advance is reached, the gross time clocking can be automatically initiated, as shown in FIG. 4B.

When predetermined gross time clocking termination operation is detected after the gross time clocking is started, the gross time clocking is terminated, as shown in FIG. 4C. The gross time is clocked as described above continuously and automatically from the initiation to the termination thereof without temporary discontinuation.

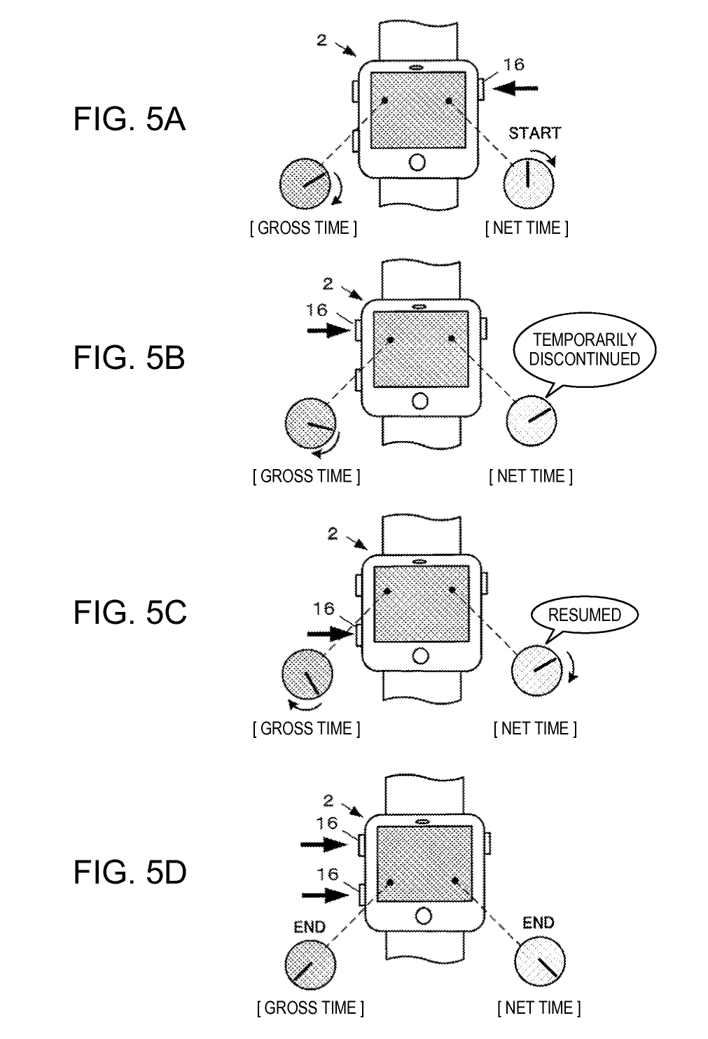

FIGS. 5A to 5D describe clocking of the net time (second cumulative time).

When an input of predetermined net time (second cumulative time) clocking initiation operation is detected concurrently with the gross time clocking or after the gross time clocking initiation, the portable apparatus 2 initiates clocking of the net time, as shown in FIG. 5A. At the same time, accumulation of travel distance since the net time clocking initiation, that is, accumulation of a “net travel distance” is initiated.

The net time clocking can be temporarily discontinued and then resumed. Specifically, when an input of predetermined clocking temporary discontinuation operation is detected during the net time clocking, the portable apparatus 2 temporarily discontinues the net time clocking, as shown in FIG. 5B. Thereafter, when an input of predetermined clocking resumption operation is detected, the net time clocking having been temporarily discontinued is resumed, as shown in FIG. 5C. That is, the time accumulation can be resumed in the form of a continuation of the time having been accumulated until the temporary discontinuation. When an input of the gross time clocking termination operation is detected, the net time clocking is also terminated, as shown in FIG. 5D.

### Description of Information Display

The portable apparatus 2 can successively calculate the following competition-related information based on the gross time, the net time, and the net travel distance: the remaining distance to a limit point that the user has not passed; the remaining period before the limit time at the limit point (deviation from gross time); the remaining period before the passage target time at the limit point (deviation from net time); the traveling pace; and expected arrival time at the limit point that the user has not passed, the expected arrival time expected based on the traveling pace and expressed in the gross time, and the portable apparatus 2 can cause the touch panel 12 to display the pieces of information described above. The above operation is called “competition-related information display.”

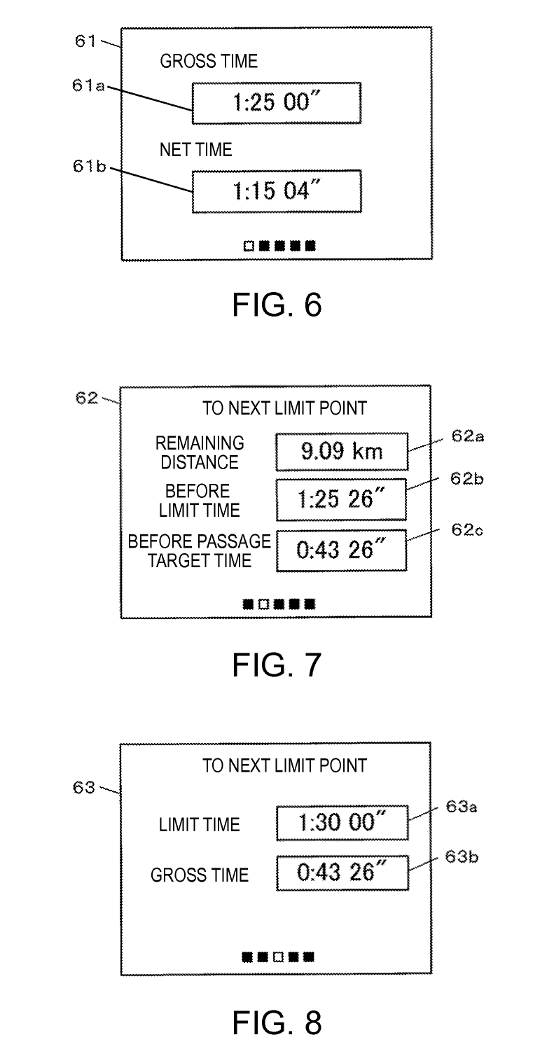

FIGS. 6 to 10 show exemplary display screens showing examples of the competition-related information display in the present embodiment. FIG. 6 shows an example of a first display format 61.

In the display format are displayed a gross time display section 61a, which displays the gross time, and a net time display section 61b, which displays the net time.

FIG. 7 shows an example of a second display format 62.

In the display format are displayed 1) a first remainder information display section 62a, which shows the remaining distance to a next limit point (limit point that the user has not passed and is closest to the current position) determined from the difference between the distance from the start point to the next limit point and the accumulated travel distance, 2) a second remainder information display section 62b, which shows the remaining period before the limit time at the next limit point determined from the difference between the limit time and the gross time, and 3) a third remainder information display section 62c, which shows the remaining period from the net time (second cumulative time) to the passage target time at the next limit point. Display sections that display next limit point identification information and the remaining distance to the finish point may, of course, further be added.

FIG. 8 shows an example of a third display format 63.

In the display format are displayed a limit time display section 63a, which shows the limit time at a next limit point, and a gross time display section 63b. The display format may be so configured that the display for a limit point can be switched to the display for another limit point whenever predetermined point switching operation is inputted.

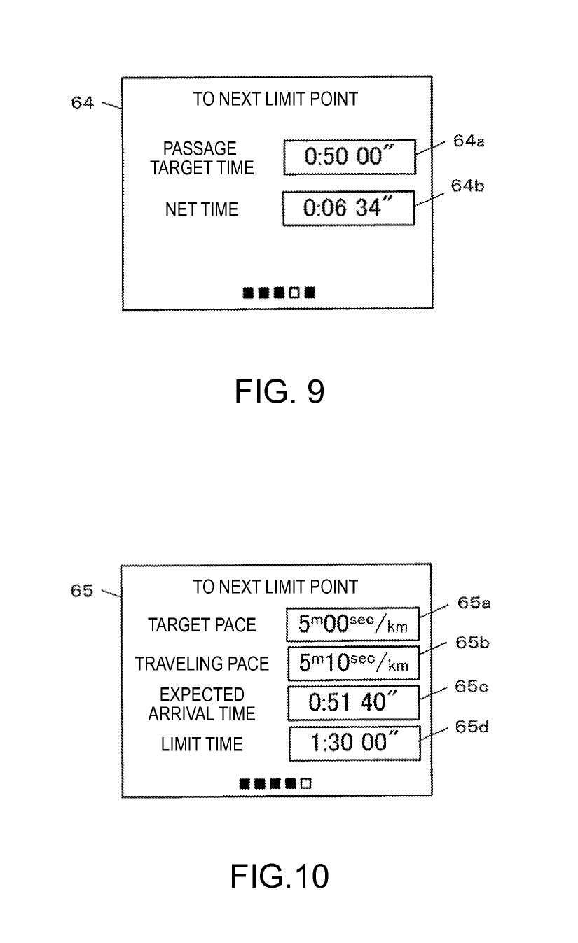

FIG. 9 shows an example of a fourth display format 64.

In the display format are displayed a passage target time display section 64a, which shows the passage target time at a next limit point, and a net time display section 64b, which shows the net time. The display format may be so configured that the display for a limit point can be switched to the display for another limit point whenever predetermined point switching operation is inputted.

FIG. 10 shows an example of a fifth display format 65.

In the display format are displayed 1) a target pace display section 65a, which displays the target pace maintained until a next limit point is reached, 2) traveling pace display section 65b, which shows a traveling pace determined from the net time and the travel distance, 3) an expected arrival time display section 65c, which shows expected arrival time (expressed with respect to gross time) when the user is expected to arrive at the next limit point and which is determined from the traveling pace, the remaining distance to the next limit point, and the gross time, and 4) a limit time display section 65d, which shows the limit time at the next limit point.

The user 1 can therefore check the two types of elapsed time at once by looking at the display screen expressed in the first display format 61 (FIG. 6). The user 1 can further obtain information necessary to determine whether the user only needs to keep running to the next limit point at the current pace or whether the user needs to increase the current pace by looking at the display screens expressed in the second display format 62 (FIG. 7) to the fifth display format 65 (FIG. 10).

How to display the competition-related information is not limited to the display formats described above, which can be changed as appropriate. For example, the number of pieces of information and the combination thereof displayed in each of the display formats can be changed as appropriate. The method for displaying the competition-related information can also be so changed that the text-based display shown in FIGS. 6 to 10 is replaced, for example, with display based on graphs, symbols, or display colors. For example, the background of the display screen may be changed. Specifically, displaying the target pace and the traveling pace may be replaced with (or may be combined with) comparing the target pace and the traveling pace with each other, and a first background may be used (blue background may be used, for example) when the traveling pace is greater than the target pace, whereas a second background may be used (red background may be used, for example) when the traveling pace is smaller than the target pace. The background may instead be so displayed that the background color is blinked when the difference between the traveling pace and the target pace becomes large and the blinking intervals are narrowed as the difference increases. As another example, the background screen or background pattern can be so displayed that it flows. In this case, when the traveling pace is greater than the target pace, the background screen or background pattern is displayed to flow upward, whereas when the traveling pace is smaller than the target pace, the background screen or background pattern is displayed to flow downward. Further, the greater the difference between the traveling pace and the target pace is, the faster the speed of the flowing display can be.

### Description of Functional Configuration

The functional configuration in the present embodiment will next be described.

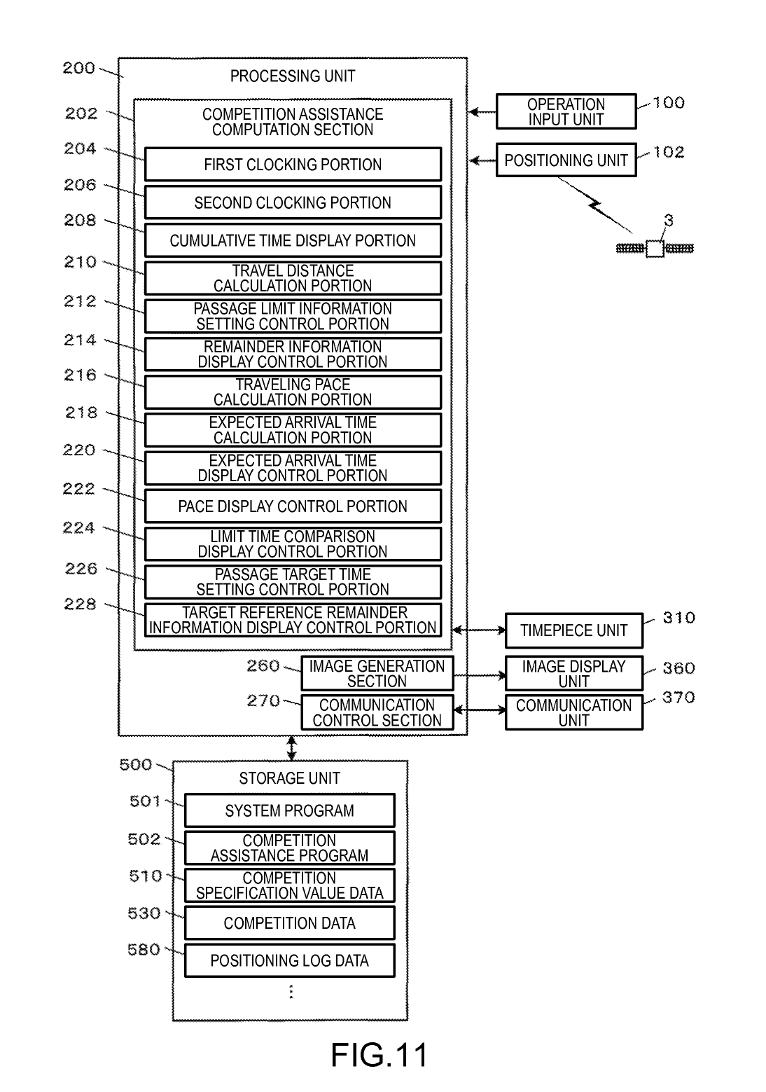

FIG. 11 is a functional block diagram showing an example of the functional configuration in the present embodiment.

The portable apparatus 2 includes an operation input unit 100, a positioning unit 102, a processing unit 200, a timepiece unit 310, an image display unit 360, a communication unit 370, and a storage unit 500.

The operation input unit 100 outputs an operation input signal to the processing unit 200 in accordance with a variety of operation inputs issued by the user 1. For example, the operation input unit 100 can be achieved by using a device directly operated with a finger of a hand of the user, such as a button switch and a touch panel, or even a device that senses movement or attitude, such as an acceleration sensor, an angular velocity sensor, an inclination sensor, and a geomagnetism sensor. The touch panel 12 and the operation switches 16 shown in FIG. 1 correspond to the operation input unit 100.

The positioning unit 102 receives a signal from the positioning system, calculates positioning information, and outputs the positioning information to the processing unit 200. The positioning module 28 shown in FIG. 1 corresponds to the positioning unit 102.

The processing unit 200 is achieved, for example, by using electronic parts, such as a CPU, a GPU, or any other microprocessor and an IC memory, and controls data input/output from and to the functional units including the operation input unit 100 and the storage unit 500. The processing unit 200 then carries out a variety of computation processes based, for example, on predetermined programs and data to control the action of the portable apparatus 2. The substrate 20 shown in FIG. 1 corresponds to the processing unit 200. The processing unit 200 further corrects time clocked by the timepiece unit 310 (clock time) to local standard time by using information on the position and date/time contained in the positioning information calculated by the positioning unit 102.

The processing unit 200 in the present embodiment includes a competition assistance computation section 202, an image generation section 260, and a communication control section 270.

The competition assistance computation section 202 carries out a variety of competition-assistance-related control processes. For example, the competition assistance computation section 202 can set a variety of competition-related specification values in accordance with operation inputs from the user 1 and store the inputted specification values as competition specification value data 510 in the storage unit 500. The competition assistance computation section 202 can further record the positioning information provided in a time series manner from the positioning unit 102 as positioning log data 580 in the storage unit 500. The competition assistance computation section 202 can then carry out a variety of computation processes for calculating the variety of types of competition-related information based on the provided positioning information and presenting the user with the calculation results.

Specifically, the competition assistance computation section 202 in the present embodiment includes a first clocking portion 204, a second clocking portion 206, and a cumulative time display portion 208.

The first clocking portion 204 initiates clocking from given clocking initiation timing to clock the gross time (first cumulative time). Specifically, the first clocking portion 204 can initiate clocking of the first cumulative time based on clocking initiation timing set by detecting that given specified time (competition start specified time shown in FIGS. 2 and 3, for example) has been reached. The first clocking portion 204 may instead perform the clocking by referring to the time clocked by the timepiece unit 310.

The second clocking portion 206 initiates clocking of the net time (second cumulative time) concurrently with or after the gross time clocking initiation timing and clocks the net time in such a way that the clocking can be temporarily discontinued and the temporary discontinuation can be released during the gross time clocking in accordance with an operation input from the user. The second clocking portion 206 may instead perform the clocking by referring to the time clocked by the timepiece unit 310.

The cumulative time display portion 208 controls display of the gross time (first cumulative time) and the net time (second cumulative time). The display control associated with the first display format 61 shown in FIG. 6 corresponds to the control described above.

The competition assistance computation section 202 in the present embodiment further includes a travel distance calculation portion 210, a passage limit information setting control portion 212, and a remainder information display control portion 214.

The travel distance calculation portion 210 uses the positioning result from the positioning unit 102, that is, the provided positioning information to accumulate the travel distance from a given start point. Specifically, the travel distance calculation portion 210 accumulates the travel distance since the clocking initiation timing at which the second clocking portion 206 initiates the clocking.

The passage limit information setting control portion 212 sets, in accordance with an operation input from the user, information on a limit point and limit time expressed by the time (or clock time) having elapsed from the clocking initiation timing from which the first cumulative time is clocked. The setting input control performed in the sub-pages P2, P3, . . . in the competition specification value input screen W2 shown in FIG. 3 correspond to the setting described above.

The remainder information display control portion 214 controls display of the remaining period before limit time and the remaining distance to the corresponding limit point. The display control associated with the second display format 62 shown in FIG. 7 corresponds to the control described above.

The competition assistance computation section 202 in the present embodiment further includes a traveling pace calculation portion 216, an expected arrival time calculation portion 218, an expected arrival time display control portion 220, and a pace display control portion 222.

The traveling pace calculation portion 216 uses the positioning result from the positioning unit 102 to calculate the traveling pace. For example, the traveling pace calculation portion 216 calculates the traveling pace in the form of a period required for the user to run a predetermined unit distance (1 km, for example).

The expected arrival time calculation portion 218 uses the latest traveling pace to calculate expected arrival time at a limit point provided that the user keeps traveling at the latest traveling pace.

The expected arrival time display control portion 220 controls display of limit time and the expected arrival time. The display control associated with the fifth display format 65 shown in FIG. 10 corresponds to the control described above.

The pace display control portion 222 controls display of a given target pace and the traveling pace. The display control associated with the fifth display format 65 shown in FIG. 10 corresponds to the control described above.

The competition assistance computation section 202 in the present embodiment further includes a limit time comparison display control portion 224, a passage target time setting control section 226, and a target reference remainder information display control portion 228.

The limit time comparison display control portion 224 controls display of limit time and the gross time (first cumulative time). The display control associated with the third display format 63 shown in FIG. 8 corresponds to the control described above.

The passage target time setting control section 226 controls, in accordance with an operation input from the user, setting of passage target time at which the user passes a given passage point expressed in distance. The setting input control performed on each of the sub-pages in the race specification value setting shown in FIG. 3 corresponds to the control described above, and the user can perform the setting control by arbitrarily setting a limit point aside from the official limit points in the competition.

The target reference remainder information display control portion 228 controls display of the remaining period from the net time (second cumulative time) to passage target time and the remaining distance to a passage point. The display control associated with the second display format 62 shown in FIG. 7 corresponds to the control described above.

The image generation section 260 is achieved, for example, by using a CPU, a driver IC that drives a liquid crystal display, a GPU (graphic processing unit), a program, such as a video codec, and a drawing frame IC memory. The image generation section 260 controls the image display unit 360 to display a variety of images.

The image display unit 360 displays a variety of images based on a control signal inputted from the image generation section 260. The image display unit 360 can be achieved, for example, by using a flat-panel display or any other image display device. The touch panel 12 shown in FIG. 1 corresponds to the image display unit 360.

The communication control section 270 performs data processing associated with data communication and sends and receives data to and from an external apparatus via the communication unit 370.

The communication unit 370 achieves data communication with an external apparatus. The communication unit 370 is achieved, for example, by using a wireless communication device, a jack of a communication cable for wired communication, or a control circuit. The short-range wireless module 29 shown in FIG. 1 corresponds to the communication unit 370.

The timepiece unit 310 is formed, for example, of a clocking circuit having a quartz oscillator and clocks the local standard time (clock time).

The storage unit 500 stores programs, a variety of initial setting data, and other types of information for achieving the functions that allow the processing unit 200 to oversee and control the portable apparatus 2. The storage unit 500 is also used as a work area where the processing unit 200 performs computation and can temporarily store input data inputted from the operation input unit 100, measurement result data measured by the positioning section 102, and other data. The functions of the storage unit 500 can be achieved, for example, by using a RAM, a flash memory, or any other IC memory. The main memory 24 and the measured data memory 26 mounted on the substrate 20 in FIG. 1 correspond to the storage unit 500.

The storage unit 500 in the present embodiment stores a system program 501, a competition assistance program 502, a competition specification value data 510, competition data 530, and a positioning log data 580. The storage unit 500 can further store a clocking timer, a flag, and other types of information as appropriate.

The system program 501 is a program for providing the portable apparatus 2 with basic functions of a computer. The competition assistance program 502 is application software that is read and executed by the processing unit 200 to achieve the function of the competition assistance computation section 202. The competition assistance program 502 may instead be incorporated in the system program 501 as part thereof.

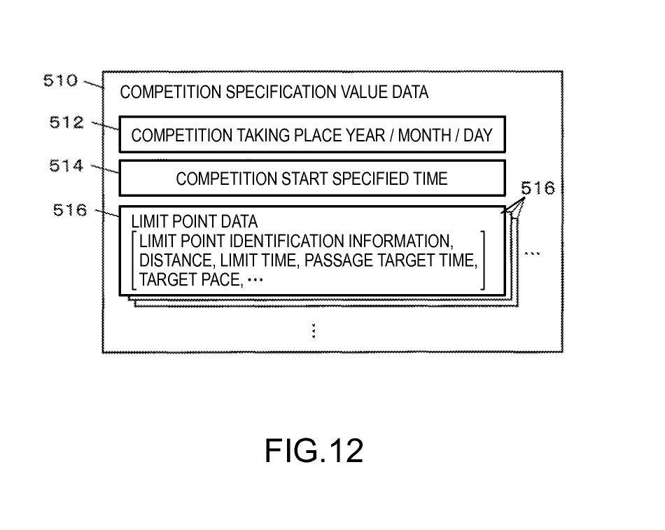

The competition specification value data 510 stores competition specification values inputted through operation performed by the user 1. For example, the competition specification value data 510 includes competition taking place year/month/day 512, competition start specified time 514, and limit point data 516, as shown in FIG. 12. The competition taking place year/month/day 512 and competition start specified time 514 store the variety of parameter values inputted to the input fields 40 and 41 in the competition specification value input screen W2.

The limit point data 516 is a data set on a limit point basis and includes the limit point identification information (limit point ID), the distance from the start point, the limit time, the passage target time, and the target pace in the present embodiment. That is, the limit point data 516 stores the variety of parameter values inputted to the input fields 42 to 46 in the competition specification value input screen W2 (FIG. 3).

The competition specification value data 510 can, of course, store any other parameter value in relation to an input field in the competition specification value input screen W2.

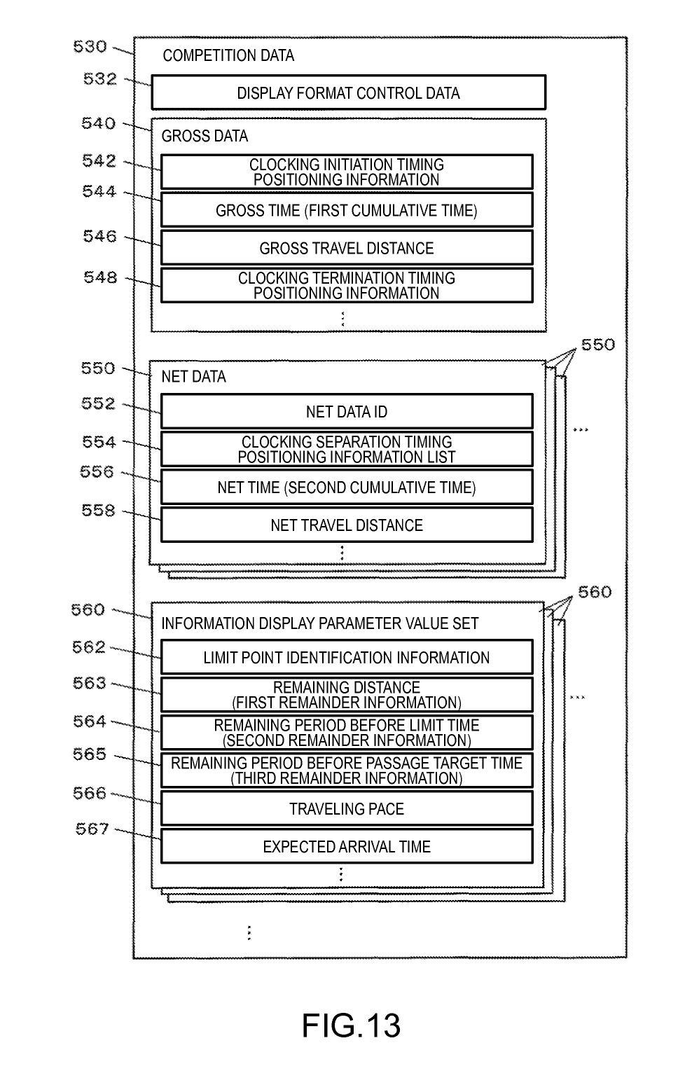

The competition data 530 is a data set provided on a competition event basis and stores information related to a competition in each competition event. The competition data 530 stores, for example, display format control data 532, gross data 540, net data 550, and an information display parameter value set 560, as shown in FIG. 13.

The display format control data 532 is information for controlling and defining a display format according to which competition-related information is displayed on the touch panel 12. In the present embodiment, the first display format 61 (FIG. 6) to the fifth display format 65 (FIG. 10) are taken as a single information display screen, and a range thereof to be actually displayed on the touch panel 12 can be selected through scroll operation. The display format control data 532 can therefore be control data for the scrolled display, for example, coordinates representing a displayed range. In a case where a variety of display formats according to which competition-related information is displayed are changed from one to another by stepwise page turning, the display format control data 532 may be page numbers, display format IDs, or other suitable values.

The gross data 540 stores a variety of data on the gross time (first cumulative time) clocking. The gross data 540 stores, for example, gross time clocking initiation timing positioning information 542, gross time 544, gross travel distance 546, which is the travel distance accumulated over the gross time clocking period, and clocking termination timing positioning information 548. The gross data 540 can, of course, store other parameter values.

The net data 550 is generated on a net time (second cumulative time) basis and stores a variety of data on the net time clocking. The net data 550 stores, for example, net data ID 552, which is automatically assigned whenever the net data is generated, a clocking separation timing positioning information list 554, which stores positioning information at the timing of each of the clocking initiation, clocking temporary discontinuation, clocking resumption, and clocking termination of the second cumulative time, net time 556, and a net travel distance 558, which is the travel distance accumulated for the net time (second cumulative period) clocking period. The net data 550 can, of course, store other parameter values.

The information display parameter value set 560 stores a variety of parameter values for displaying competition-related information. In the present embodiment, one information display parameter value set 560 is created by the competition assistance computation section 202 on a limit point basis and updated at a predetermined cycle (every second or whenever positioning is performed, for example) after the gross time clocking is initiated. One information display parameter value set 560 includes limit point identification information 562 (corresponding to limit point identification information in limit point data 516 in FIG. 12), a remaining distance 563 (first remainder information), remaining period 564 before limit time (second remainder information), remaining period 565 before passage target time, a traveling pace 566, and expected arrival time 567.

The positioning log data 580 is a time-series record of measurement results from the positioning section 102, that is, positioning information. In the present embodiment, the positioning log data 580 is time-series data from the gross time (first cumulative time) clocking initiation to the gross time clocking termination, but the recording operation may be initiated and terminated in accordance with predetermined positioning initiation/termination operation different from that in the competition assistance.

### Description of Process Procedure

The action of the portable apparatus 2 will next be described.

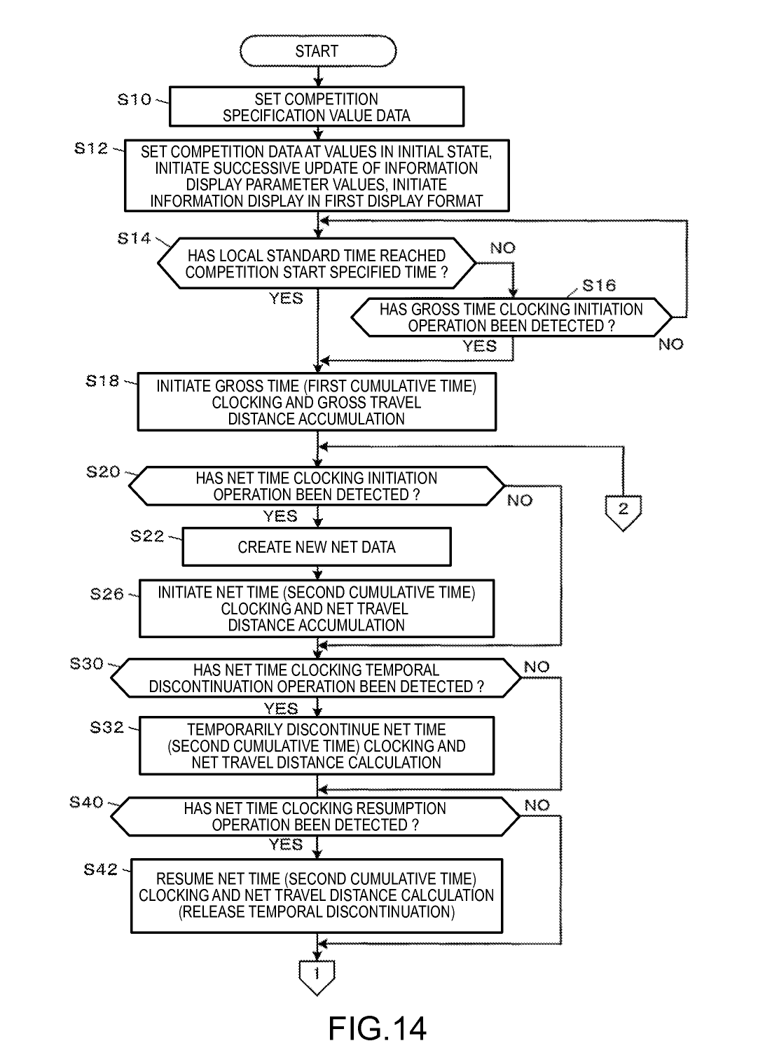

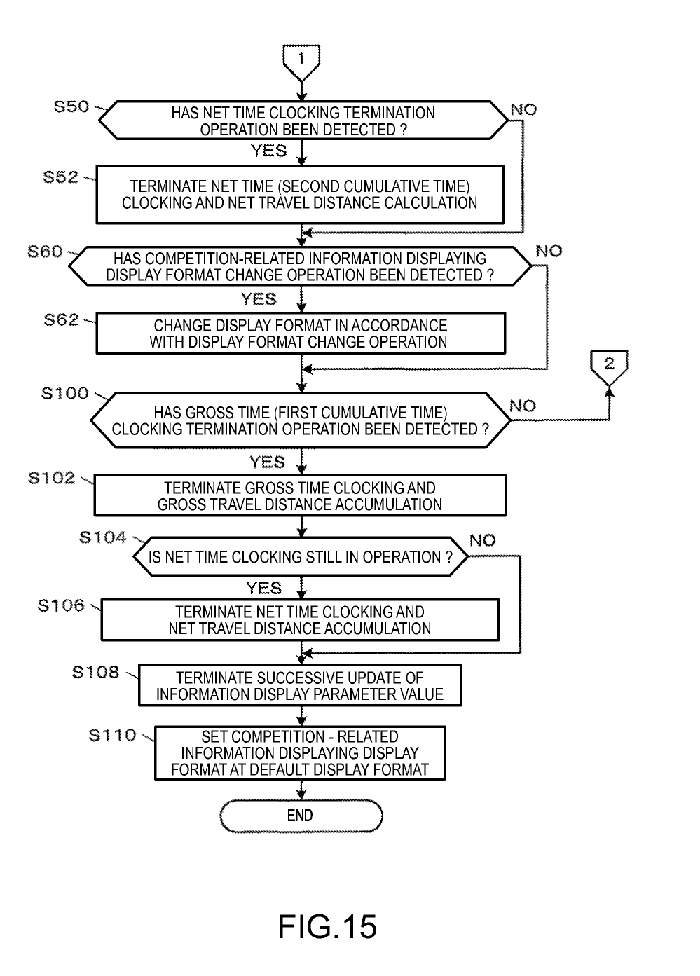

FIGS. 14 and 15 are flowcharts for describing the procedure of processes associated with the competition assistance in the portable apparatus 2 in the present embodiment. The procedure of a series of processes that will be described below is achieved, for example, when the processing unit 200 detects predetermined competition assistance function activation initiation operation and reads and executes the competition assistance program 502. Alternatively, the program has been already read and is in operation, and the program is on standby to receive the activation operation. It is assumed that the positioning section 102 always performs the positioning performed as long as the portable apparatus 2 is powered on.

First, the processing unit 200 carries out a process of setting the competition specification value data 510 (step S10), as shown in FIG. 14. Specifically, the input screen shown in FIG. 3 is displayed to allow the user to input setting values into the input fields 40 to 46. For example, the main page P1 is first displayed. After the competition taking place year/month/day input filed 40 and the competition start specified time input field 41 are filled in, the sub-page P2 is newly displayed. After specification values associated with a new limit point (including passage point arbitrarily set by user 1) are inputted, another new sub-page P3 is automatically displayed to allow the user to input specification values associated with another new limit point. The processes described above are repeated. The specification values, that is, parameter values inputted to the input fields 40 to 46 are stored as the competition specification value data 510 (FIG. 12) in the storage unit 500. When predetermined specification value setting completion operation is detected, the step S10 is terminated.

The processing unit 200 then creates the competition data 530, sets the display format control data 532 (FIG. 13) at predetermined default values, initiates successive update of the information display parameter value set 560, and initiates display of competition-related information (step S12).

In the present embodiment, the default values of the display format control data 532 are assumed to be those in the display format 61 (FIG. 6). The display on the touch panel 12 is therefore made based on the first display format 61, but the gross time display section 61a and the net time display section 61b show clocked time of “0” because the gross time clocking has not been initiated at this point.

When the local standard time (clock time) in the place where the competition takes place reaches the competition start specified time 514 (FIG. 12) in the competition specification value data 510 (YES in step S14), the processing unit 200 automatically initiates the gross time clocking (step S18). Specifically, the processing unit 200 stores latest positioning information in the clocking initiation timing positioning information 542 in the gross data 540 and initiates clocking of the gross time 544 and the accumulation of the gross travel distance 546 (FIG. 13).

Even when the local standard time has not reached the competition start specified time 514 (NO in step S14), but when the predetermined gross time clocking initiation operation is detected (FIG. 4A), the processing unit 200 initiates the gross time clocking (step S18).

After the gross time clocking is initiated, the gross time display section 61a displays results of successive clocking because information has been displayed in the first display format 61 on the touch panel 12 (as long as display format has not been changed). After the gross time clocking is initiated, the clocking cannot be stopped unless the predetermined gross time clocking termination operation (FIG. 4C) is detected, as described above.

After the gross time clocking is initiated, and when the predetermined net time clocking initiation operation (FIG. 5A) is detected (YES in step S20), the processing unit 200 creates new net data 550 (FIG. 13) (step S22) and initiates the net time clocking (step S24). Specifically, the processing unit 20 stores latest positioning information in the clocking separation timing positioning information list 554 and initiates the clocking of the net time 556 and the accumulation of the net travel distance 558.

After the net time clocking is initiated, the net time display section 61b displays results of successive clocking because information has been displayed in the first display format 61 on the touch panel 12 (as long as display format has not been changed).

The clocking of the net time (second cumulative time) can be temporarily discontinued and resumed, as described above.

Therefore, after the initiation of the gross time clocking, and when the net time clocking temporary discontinuation operation (FIG. 5B) is detected (YES in step S30), the processing unit 200 stores latest positioning information in the clocking separation timing positioning information list 554 and temporarily discontinues the clocking of the net time 556 and the accumulation of the net travel distance 558 (step S32).

Further, after the gross time clocking is initiated, and when the net time clocking resumption operation (FIG. 5C) is detected (YES in step S40), the processing unit 200 stores latest positioning information in the clocking separation timing positioning information list 554 and resumes the clocking of the net time 556 and the accumulation of the net travel distance 558 (step S42).

Referring to FIG. 15, after the gross time clocking is initiated, and when the net time clocking termination operation (FIG. 5D) is detected (YES in step S50), the processing unit 200 stores latest positioning information in the clocking separation timing positioning information list 554 and terminates the clocking of the net time 556 and the accumulation of the net travel distance 558 (step S52).

Further, after the gross time clocking is initiated, and when display format change operation of changing the display format according to which competition-related information is displayed is detected (YES in step S60), the processing unit 200 changes the display format in accordance with the display format change operation (step S62). In the present embodiment, in which the display format is changed in a scroll fashion, when flick operation performed by the user 1 on the touch panel 12 is detected, the current display format is changed to the following display format whenever the flick operation is performed and the display format control data 532 is changed.

After the gross time clocking is initiated, and when the gross time clocking termination operation is detected (YES in step S100), the processing unit 200 terminates the clocking of the gross time 544 and the accumulation of the gross travel distance 546 (step S102). Further, if the net time clocking is still in operation at this point (YES in step S104), the processing unit 200 terminates the clocking of the net time 556 and the accumulation of the net travel distance 558 (step S106).

The processing unit 200 then terminates the successive update of the information display parameter value set 560 (step S108), causes the competition-related information displaying display format to return to the default display format (step S110), and terminates the series of processes.

As described above, according to the present embodiment, in a competition in which a large number of participants are involved, such as a marathon event, the gross time (first cumulative time) and the net time (second cumulative time) can be separately clocked and a user can be provided with a variety of types of information related to the competition. Further, the gross time clocking can, of course, be initiated by an operation input from the user himself/herself and even can be automatically initiated when specified time is reached. For example, even when the user cannot hear start signal gun due, for example, to noise in an environment around the competition venue, gross time (first cumulative time) can be accurately clocked with respect to official specified time.

The user 1 can always grasp official time in the competition and competition period associated with the user 1 because the first display format (FIG. 6) allows both the gross time and the net time to be displayed at the same time.

Further, among the second display format 62 (FIG. 7) to the fifth display format 65 (FIG. 10), the user 1 can select an information display format according to his/her preference and obtain information for determining whether the current running pace is adjusted. In particular, in a marathon event or any other running competition in which a limit point is provided not to allow a participant who cannot pass the limit point in limit time to continue the competition (what is called check point), information that allows the user to determine whether the pace is adjusted is very important, whereby the portable apparatus 2 can provide the user with a large amount of merit.

### Variations

The embodiment to which the invention is applied has been described, but a form to which the invention is applied is not limited to the embodiment described above, and addition, omission, and change of the components in the embodiment can be made as appropriate.

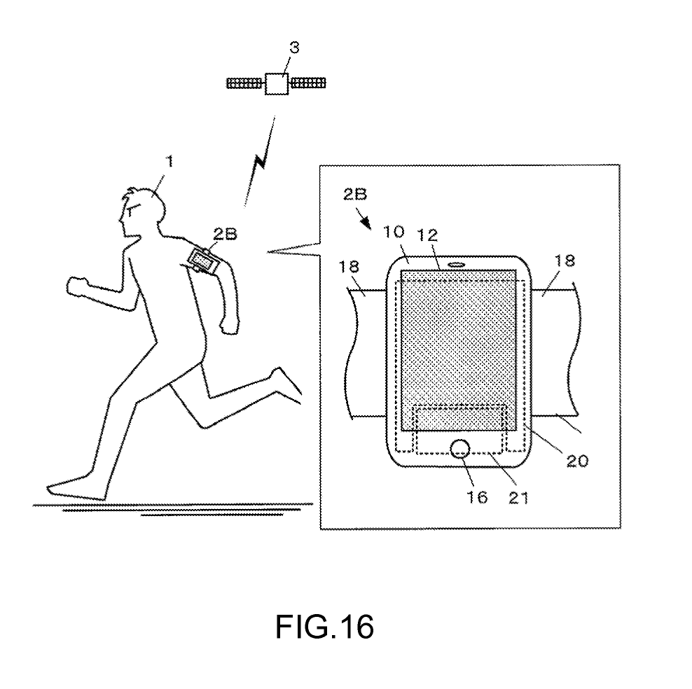

For example, in the embodiment described above, the portable apparatus 2 is presented as an apparatus worn around a wrist of the user 1, but the portion of user's body to which the portable apparatus 2 is attached can be changed as appropriate. For example, as indicated by a portable apparatus 2B shown in FIG. 16, it may be contemplated that the band 18 is primarily used to attach the portable apparatus to an upper arm portion of the user 1. Instead, a portable apparatus may be so designed that the band 18 allows the portable apparatus to be worn around the head as if the portable apparatus were goggles. In this case, the portable apparatus 2 does not necessarily have an exterior appearance of a wristwatch and may have an appropriately set exterior appearance of a tablet, Action Cam, or goggles. Further, when the portable apparatus 2 is small enough, the band 18 may be replaced with a structure with a temple shape of glasses for eyewear-shaped exterior appearance.

Further, in the embodiment described above, the case where the GPS is used as the positioning system has been described. The positioning system may instead be WAAS (Wide Area Augmentation System), QZSS (Quasi Zenith Satellite System), GLONASS (GLObal NAvigation Satellite System), GALILEO, or any other satellite positioning system.

Further, in the embodiment described above, the net time (second cumulative time) clocking is initiated immediately after the gross time (first cumulative time) clocking is initiated but can instead be initiated concurrently with the gross time clocking. Specifically, the process in step S26 only needs to be added to the process in step S18. Instead, the gross time clocking initiation operation may be formed of the following two types of operation: operation of initiating only the gross time clocking; and operation of simultaneously initiating both the gross time clocking and the net time clocking. The latter operation is then used to simultaneously initiate both the gross time clocking and the net time clocking.

The entire disclosure of Japanese Patent Application No. 2013-209933, filed Oct. 7, 2013 is expressly incorporated by reference herein.

What is claimed is:

1. A portable apparatus comprising:
a first clocking section that initiates clocking from given clocking initiation timing and clocks a first cumulative time;
a second clocking section that initiates clocking concurrently with or after the clocking initiation timing and clocks a second cumulative time; and
a cumulative time display control section that controls display of the first cumulative time and the second cumulative time.

2. The portable apparatus according to claim 1,
wherein the first clocking section initiates the clocking of the first cumulative time at given specified time as the clocking initiation timing.

3. The portable apparatus according to claim 1, further comprising:
a positioning section;
a travel distance calculation section that calculates a travel distance from a given start point by using a positioning result from the positioning section;
a passage limit information setting section that sets, in accordance with an operation input from a user and by using a positioning result from the positioning section, limit time expressed in the form of a period having elapsed from the clocking initiation timing or in the form of time and a limit point that represents a point which is expressed in distance from a first point to a second point over which the user travels and where the user unable to pass the point in the limit time is rejected; and
a remainder information display control section that controls display of a remaining period before the limit time and a remaining distance to the limit point by using a positioning result from the positioning section.

4. The portable apparatus according to claim 3, further comprising:
a traveling pace calculation section that calculates a traveling pace by using a positioning result from the positioning section;
an expected arrival time calculation section that calculates expected arrival time at which the user arrives at the limit point by using the traveling pace; and
an expected arrival time display control section that controls display of the limit time and the expected arrival time.

5. The portable apparatus according to claim 4, further comprising
a pace display control section that controls display of a given target pace and the traveling pace.

6. The portable apparatus according to claim 3,
wherein the limit time is expressed in a period having elapsed from the clocking initiation timing, and
the portable apparatus further comprises
a limit time comparison display control section that controls display of the limit time and the first cumulative time.

7. The portable apparatus according to claim 3, further comprising:
a passage target time setting section that expresses a passage point in distance from a third point to a fourth point over which the user travels and sets, in accordance with an operation input from the user, passage target time at which the user passes the passage point; and
a target reference remainder information display control section that controls display of a remaining period from the second cumulative time to the passage target time and a remaining distance to the passage point.

8. A cumulative time display control method comprising:
initiating clocking from given clocking initiation timing and clocking a first cumulative time;
initiating clocking concurrently with or after the clocking initiation timing and clocking a second cumulative time; and
displaying the first cumulative time and the second cumulative time.
